(19) United States
(12) Patent Application Publication
(10) Pub. No.: US 2026/0220968 A1
(43) Pub. Date: Jul. 30, 2026

(54) INFORMATION PROCESSING SYSTEM, LEARNING APPARATUS, COMPARISON APPARATUS, INFORMATION PROCESSING METHOD, AND NON-TRANSITORY COMPUTER READABLE MEDIUM

(71) Applicants: NEC Corporation, Tokyo (JP); The University of Electro-Communications, Tokyo (JP)

(72) Inventors: Takahiro TOIZUMI, Tokyo (JP); Yuho SHOJI, Tokyo (JP); Yuka OGINO, Tokyo (JP); Masatsugu ICHINO, Tokyo (JP); Rikuto OTSUKA, Tokyo (JP)

(73) Assignees: NEC Corporation, Tokyo (JP); The University of Electro-Communications, Tokyo (JP)

(21) Appl. No.: 19/143,623

(22) PCT Filed: Dec. 27, 2022
(86) PCT No.: PCT/JP2022/048299

§ 371 Date: Jun. 26, 2025

(51) Int. Cl. G06V 40/18; G06V 10/764; G06V 10/774; G06V 10/98

(52) U.S. Cl. CPC G06V 40/193; G06V 10/764; G06V 10/774; G06V 10/993; G06V 40/197

(57) ABSTRACT

An information processing system (100) includes an extraction unit (112), a computation unit (113), and an updating unit (114). The extraction unit (112) uses an extraction model of training with, as an input, an image for training including an iris, and thereby extracts iris information relating to the iris. The computation unit (113) computes, by use of resolution of an iris region included in the image for training, a loss between the iris information and ground truth information. The updating unit (114) updates, by use of the computed loss, a value of a parameter of the extraction model.

### TECHNICAL FIELD

This disclosure relates to an information processing system, a learning apparatus, a comparison apparatus, an information processing method, and a medium.

### BACKGROUND ART

Various techniques that utilize a learning model have been proposed in order to extract an iris feature (feature of an iris) used in iris recognition and the like (e.g., see Patent Documents 1 to 3). For example, Patent Document 2 describes using, as a loss, L2 softmax loss, cosine loss, ArcFace, CosFace, SphereFace, AdaCos, or the like.

Note that, Non-Patent Documents 1 to 4 disclose CosFace, ArcFace, MagFace, and T-center that are examples of loss functions.

### RELATED DOCUMENT

### Patent Document

Patent Document 1: International Patent Publication No. WO2022/208606
Patent Document 2: International Patent Publication No. WO2022/195819
Patent Document 3: International Patent Publication No. WO2022/185436

### Non-Patent Document

Non-Patent Document 1: Hao Wang, seven others, “CosFace: Large Margin Cosine Loss for Deep Face Recognition”, [online], CVPR 2018, [searched on Dec. 20, 2022], Internet <URL: https://openaccess.thecvf.com/content_cvpr_2018/html/Wang_CosFace_Large_Margin_CVPR_2018_paper.html>
Non-Patent Document 2: Jiankang Deng, two others, “ArcFace: Additive Angular Margin Loss for Deep Face Recognition”, [online], CVPR 2019, [searched on Dec. 20, 2022], Internet <URL: https://openaccess.thecvf.com/content_CVPR_2019/html/Deng_ArcFace_Additive_Angular_Margin_Loss_for_Deep_Face_Recognition_CVPR_2019_paper.html>
Non-Patent Document 3: Qiang Meng, three others, “MagFace: A Universal Representation for Face Recognition and Quality Assessment”, [online], 2021 IEEE Conference Publication, [searched on Dec. 20, 2022], Internet <URL: https://ieeexplore.ieee.org/document/9578764>
Non-Patent Document 4: Yifeng Chen, two others, “T-Center: A Novel Feature Extraction Approach Towards Large-Scale Iris Recognition”, [online], Feb. 12, 2020, IEEE, [searched on Dec. 20, 2022], Internet <URL: https://ieeexplore.ieee.org/document/8995585>

### SUMMARY

### Technical Problem

This disclosure aims to improve upon techniques described in the related documents described above.

### Solution to Problem

According to one aspect of the present invention, there is provided an information processing system including:
an extraction unit that uses an extraction model of training with, as an input, an image for training including an iris, and thereby extracts iris information relating to the iris;
a computation unit that computes, by use of resolution of an iris region included in the image for training, a loss between the iris information and ground truth information; and
an updating unit that updates, by use of the computed loss, a value of a parameter of the extraction model.

According to one aspect of the present invention, there is provided a learning apparatus including:
an extraction unit that uses an extraction model with, as an input, an image for training including an iris, and thereby extracts iris information relating to the iris;
a computation unit that computes, by use of resolution of an iris region included in the image for training, a loss between the iris information and ground truth information; and
an updating unit that updates, by use of the computed loss, a value of a parameter of the extraction model.

According to one aspect of the present invention, there is provided a comparison apparatus including:
an extraction unit for comparison that extracts with, as an input, a target image including an iris of a target, iris information relating to the iris of the target, by use of the extraction model trained by use of the training apparatus according to claim 11; and
a comparison unit that compares the iris information of the target with previously registered registration data.

According to one aspect of the present invention, there is provided an information processing method including,
by a first computer group made up of one or more computers:
using an extraction model of training with, as an input, an image for training including an iris, and thereby extracting iris information relating to the iris;
computing, by use of resolution of an iris region included in the image for training, a loss between the iris information and ground truth information; and
updating, by use of the computed loss, a value of a parameter of the extraction model.

According to one aspect of the present invention, there is provided an information processing method including,
by a second computer group made up of one or more computers:
extracting with, as an input, a target image including an iris of a target, iris information relating to the iris of the target, by use of the extraction model that the first computer group has trained by executing the information processing method according to claim 13; and
comparing the iris information of the target with previously registered registration data.

According to one aspect of the present invention, there is provided a medium recording a program for causing
a first computer group made up of one or more computers to execute:
using an extraction model of training with, as an input, an image for training including an iris, and thereby extracting iris information relating to the iris;
computing, by use of resolution of an iris region included in the image for training, a loss between the iris information and ground truth information; and
updating, by use of the computed loss, a value of a parameter of the extraction model.

According to one aspect of the present invention, there is provided a medium recording a program for causing
a second computer group made up of one or more computers to execute:
extracting with, as an input, a target image including an iris of a target, iris information relating to the iris of the target, by use of the extraction model trained by causing the first computer group to execute a program recorded on the medium according to claim 15; and
comparing the iris information of the target with previously registered registration data.

### BRIEF DESCRIPTION OF THE DRAWINGS

FIG. 1 is a diagram illustrating an outline of an information processing system according to a first example embodiment.

FIG. 2 is a diagram illustrating an outline of a learning apparatus according to the first example embodiment.

FIG. 3 is a diagram illustrating an outline of a comparison apparatus according to the first example embodiment.

FIG. 4 is a flowchart illustrating an outline of a first example of information processing according to the first example embodiment.

FIG. 5 is a flowchart illustrating an outline of a second example of information processing according to the first example embodiment.

FIG. 6 is a diagram illustrating a configuration example of the information processing system according to the first example embodiment.

FIG. 7 is a diagram illustrating a functional configuration example of the learning apparatus according to the first example embodiment.

FIG. 8 is a diagram illustrating one example of an image for training.

FIG. 9 illustrates a functional configuration example of a parameter computation unit.

FIG. 10 is a diagram illustrating a physical configuration example of a learning apparatus 101 according to the first example embodiment.

FIG. 11 is a flowchart illustrating an example of learning processing according to the first example embodiment.

FIG. 12 is a flowchart illustrating an example of parameter computation processing according to the first example embodiment.

### EXAMPLE EMBODIMENT

Hereinafter, one example embodiment of the present invention is described by use of the drawings. Note that, in all of the drawings, a similar component is assigned with a similar reference sign, and description thereof is omitted as appropriate.

### First Example Embodiment

### Outline

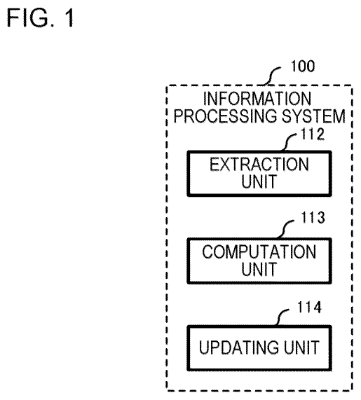

FIG. 1 is a diagram illustrating an outline of an information processing system 100 according to a first example embodiment. The information processing system 100 includes an extraction unit 112, a computation unit 113, and an updating unit 114.

The extraction unit 112 uses an extraction model of training with, as an input, an image for training including an iris, and thereby extracts iris information relating to the iris.

The computation unit 113 computes, by use of resolution of an iris region included in the image for training, a loss between the iris information and ground truth information.

The updating unit 114 updates, by use of the computed loss, a value of a parameter of the extraction model.

The information processing system 100 enables, even in a case where resolution of an iris region is low in a target image including an iris of a target, to acquire information with good accuracy from an image of the iris region.

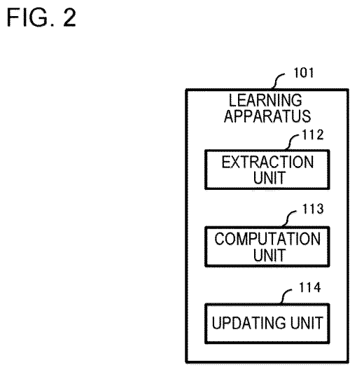

FIG. 2 is a diagram illustrating an outline of a learning apparatus 101 according to the first example embodiment. The learning apparatus 101 includes an extraction unit 112, a computation unit 113, and an updating unit 114.

The extraction unit 112 uses an extraction model of training with, as an input, an image for training including an iris, and thereby extracts iris information relating to the iris.

The computation unit 113 computes, by use of resolution of an iris region included in the image for training, a loss between the iris information and ground truth information.

The updating unit 114 updates, by use of the computed loss, a value of a parameter of the extraction model.

The learning apparatus 101 enables, even in a case where resolution of an iris region is low in a target image including an iris of a target, to acquire information with good accuracy from an image of the iris region.

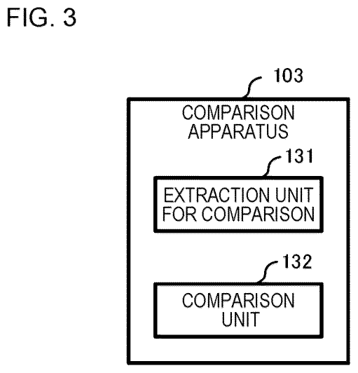

FIG. 3 is a diagram illustrating an outline of a comparison apparatus 103 according to the first example embodiment. The comparison apparatus 103 includes a unit for comparison 131 and a comparison unit 132.

The extraction unit for comparison 131 extracts with, as an input, a target image including an iris of a target, iris information relating to the iris of the target, by use of the extraction model trained by use of the learning apparatus 101.

The comparison unit 132 compares the iris information of the target with previously registered registration data.

The comparison apparatus 103 enables, even in a case where resolution of an iris region is low in a target image including an iris of a target, to acquire information with good accuracy from an image of the iris region.

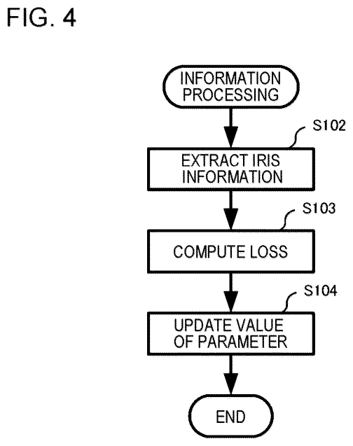

FIG. 4 is a flowchart illustrating an outline of a first example of information processing according to the first example embodiment.

The extraction unit 112 uses an extraction model of training with, as an input, an image for training including an iris, and thereby extracts iris information relating to the iris (step S102).

The computation unit 113 computes, by use of resolution of an iris region included in the image for training, a loss between the iris information and ground truth information (step S103).

The updating unit 114 updates, by use of the computed loss, a value of a parameter of the extraction model (step S104).

The information processing enables, even in a case where resolution of an iris region is low in a target image including an iris of a target, to acquire information with good accuracy from an image of the iris region.

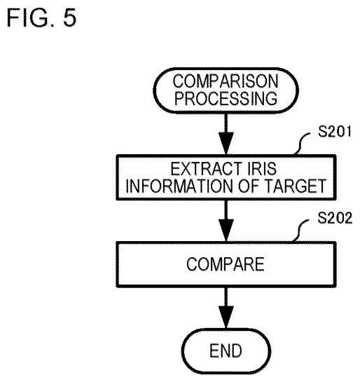

FIG. 5 is a flowchart illustrating an outline of a second example of information processing according to the first example embodiment.

The extraction unit for comparison 131 extracts with, as an input, a target image including an iris of a target, iris information relating to the iris of the target, by use of the extraction model that the learning apparatus 101 described above has trained by executing an information processing method (step S201).

The comparison unit 132 compares the iris information of the target with previously registered registration data (step S202).

The information processing enables, even in a case where resolution of an iris region is low in a target image including an iris of a target, to acquire information with good accuracy from an image of the iris region.

A detailed example of the information processing system 100 according to the first example embodiment is described below.

### Detail

Generally, in a case where a target image including an iris is acquired by capture using a camera or the like, resolution of an iris region included in the target image may be small. The resolution of the iris region is a size of the iris region included in the target image. In other words, even in a case where resolution (the number of pixels) of a target image is constant, resolution of an iris region thereof may vary.

In a case where training of a learning model for acquiring iris information (information relating to an iris) or the like from such a target image is performed, a general loss function such as that described in a related document is often used. However, in a learning model that has trained such a loss function by use of a general method, accuracy of iris information acquired from a target image may change according to resolution of an iris region. In particular, accuracy of iris information acquired from a target image with low resolution of an iris region is often lower than accuracy of iris information acquired from a target image with high resolution of an iris region.

In view of the problem described above, one example of an object of the present invention is to provide an information processing system, a learning apparatus, a comparison apparatus, an information processing method, a medium, and the like that solve, even in a case where resolution of an iris region is low in a target image including an iris of a target, acquiring information with good accuracy from an image of the iris region.

### (Configuration Example of the Information Processing System 100 According to the First Example Embodiment)

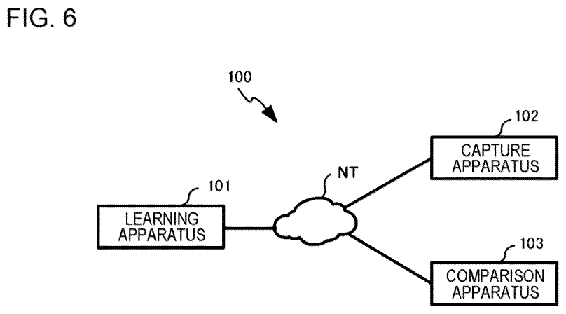

FIG. 6 is a diagram illustrating a configuration example of the information processing system 100 according to the first example embodiment. The information processing system 100 is a system for comparing a target by use of a target image and performing training of an extraction model. The extraction model is a machine learning model that outputs information used for comparison or the like, with a target image as an input.

The information processing system 100 includes the learning apparatus 101, a capture apparatus 102, and the comparison apparatus 103.

The learning apparatus 101, the capture apparatus 102, and the comparison apparatus 103 are connected to each other via a network NT configured wiredly, wirelessly, or by a combination thereof, and transmit and receive information to each other via the network NT.

The target image is an image including an iris of a target. The target is, for example, a person. Note that, the target is not limited to a person, and may be an animal such as a dog or a snake.

### (Functional Configuration Example of the Learning Apparatus 101 According to the First Example Embodiment)

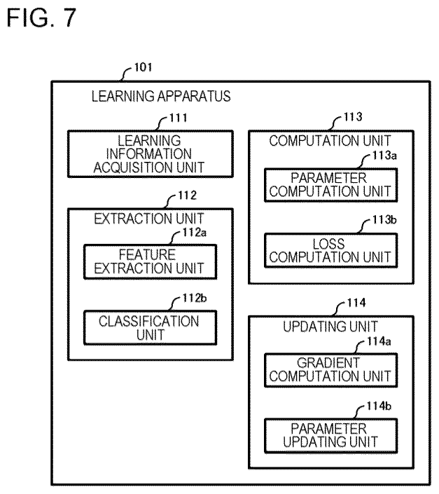

FIG. 7 is a diagram illustrating a functional configuration example of the learning apparatus 101 according to the first example embodiment. The learning apparatus 101 is an apparatus for performing training of an extraction model. The learning apparatus 101 functionally includes, for example, a learning information acquisition unit 111, the extraction unit 112, the computation unit 113, and the updating unit 114.

### (Example of a Function of the Learning Information Acquisition Unit 111)

The learning information acquisition unit 111 acquires learning information. The learning information is information for performing training of an extraction model. The learning information is preferably prepared, for example, previously.

The learning information includes, for example, an image for training, resolution of an iris region, and ground truth information.

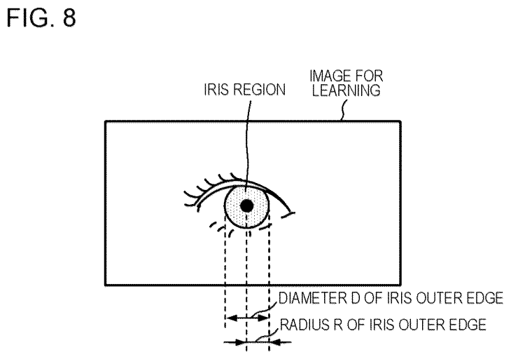

The image for training is a target image used for training of an extraction model. In other words, the image for training includes an iris of a target (target for training) used for training of the extraction model. A size (the number of pixels) of the overall image for training is, for example, a previously determined fixed value. FIG. 8 is a diagram illustrating one example of an image for training. Note that, although FIG. 8 illustrates an example in which a shape of an image for training is rectangular, the shape may be changed to an appropriate shape.

The iris region is a region indicating an iris in a target image (including an image for training), i.e., a partial region of the target image indicating the iris. In FIG. 8, the iris region is given a dot.

As described above, resolution of the iris region is a size of the iris region. The size of the iris region is, for example, the number of pixels indicating an iris diameter. The iris diameter is the number of pixels of at least one of a diameter D, a radius R, or the like of an outer edge of the iris region (i.e., an outer edge of an iris in a target image (including an image for training)) (see FIG. 8).

Resolution of the iris region included in the learning information is resolution of the iris region included in the image for training.

The ground truth information includes a ground truth of an output value from the extraction model, i.e., a ground truth of information acquired from a target image by use of the extraction model.

The ground truth information preferably includes, for example, information being associated with at least part of iris information output by the extraction model. The ground truth information preferably includes, for example, at least one of a label or a class of an iris included in the image for training, an image of an iris region, and a position of a feature location.

The label is information for identifying a class to which an iris included in the image for training belongs. The label is represented by use of, for example, a previously determined index such as a letter, a symbol, or a number.

The class is, for example, whether an iris is an iris of left or right eye, which target for training has the eye, or the like. The class is represented by use of, for example, a vector quantity such as a one-hot vector.

The feature location is at least one or more feature locations in a target image including an iris. The feature location preferably includes, for example, at least one keypoint such as a pupil center, an outer corner of an eye, an inner corner of an eye, a topmost point of an upper eyelid, a bottommost point of a lower eyelid, and the like. Moreover, for example, the feature location is not limited to a keypoint, and may include graphic information such as a radius of a circle or a longitudinal or lateral length of a rectangle. Such a feature location may be previously determined, or may be automatically decided by use of a learning model.

The present example embodiment is described by use of an example in which ground truth information includes a class.

### (Example of a Function of the Extraction Unit 112)

FIG. 7 is referred to again.

The extraction unit 112 is configured with an extraction model included therein. The extraction model is a machine learning model for extracting iris information with a target image as an input. In other words, the extraction unit 112 according to the present example embodiment extracts iris information by use of an extraction model that trains with an image for training as an input. The extraction unit 112 preferably outputs the extracted iris information to the computation unit 113.

The iris information is information relating to an iris. The iris information includes at least one of, for example, a class, a label, an iris feature, an image of an iris region, and a position of a feature location. The iris feature is a feature extracted from the iris included in a target image (including an image for training). The iris feature is, for example, a vector quantity.

The present example embodiment is described by use of an example in which iris information includes an iris feature and a class.

Specifically, for example, the extraction model includes a feature extraction model and a classification model. Each of these models is, for example, a machine learning model configured by use of a neural network, and outputs extracted information. In association with a configuration of such an extraction model, the extraction unit 112 functionally includes a feature extraction unit 112a and a classification unit 112b, as illustrated in FIG. 7.

The feature extraction unit 112a is configured with a feature extraction model included therein. The feature extraction model is a machine learning model for extracting an iris feature from a target image. The feature extraction unit 112a extracts an iris feature by use of a feature extraction model with an image for training as an input.

The classification unit 112b is configured with a classification model included therein. The classification model is a machine learning model for extracting, by use of an iris feature, a class being associated with an iris included in a target image. The classification unit 112b extracts a class being associated with an iris included in an image for training, by use of a classification model with, as an input, the iris feature that the feature extraction unit 112a has extracted from the image for training. Note that, the classification model may extract, for example, a label instead of or in addition to a class.

### (Example of a Function of the Computation Unit 113)

The computation unit 113 computes a loss between iris information and ground truth information by use of resolution of an iris region included in an image for training.

For example, ArcFace or CosFace is preferably adopted as a loss function for deriving a loss. Note that, a loss function is not limited to ArcFace or CosFace, and a loss may be, for example, L2 softmax loss, cosine loss, MagFace, T-center, SphereFace, AdaCos, or the like.

Specifically, for example, the computation unit 113 functionally includes a parameter computation unit 113a and a loss computation unit 113b, as illustrated in FIG. 7.

The parameter computation unit 113a derives a parameter value relating to a parameter for deriving a loss.

The parameter value includes, for example, at least one of the following (1) to (3). The present example embodiment is described by use of an example in which the parameter value includes the following (1) to (3).
(1) A value of a margin parameter
(2) A value of a weight decay parameter
(3) Magnitude of an iris feature

Herein, the margin parameter of (1) is a hyperparameter included in a loss function for deriving a loss. Including a value of the margin parameter in a parameter value derived by the parameter computation unit 113a is suitable, for example, in a case where ArcFace, CosFace, or the like is used as a loss function.

(2) The weight decay parameter is a hyperparameter of weight decay included in a loss function for deriving a loss.

(3) The magnitude of the iris feature is, for example, L2 norm of a feature vector representing an iris feature.

Note that, Lp norm is a positive value of a p-th root of a sum of values derived by raising, to a p-th power, an absolute value of each component included in a feature vector. For example, L1 norm is a sum of an absolute value of each component included in a feature vector. Moreover, for example, L2 norm is Euclidean norm.

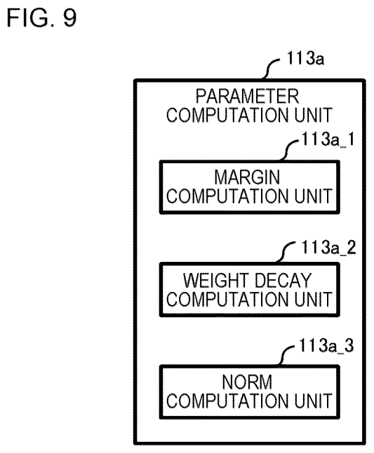

The parameter computation unit 113a includes a function for deriving, for example, each of (1) to (3). FIG. 9 is a diagram illustrating a functional configuration example of the parameter computation unit 113a. Functionally, the parameter computation unit 113a includes, for example, a margin computation unit 113a_1, a weight decay computation unit 113a_2, and a norm computation unit 113a_3.

The margin computation unit 113a_1 computes a margin parameter by use of resolution of an iris region. The weight decay computation unit 113a_2 computes a weight decay value by use of resolution of an iris region. The norm computation unit 113a_3 derives magnitude of an iris feature.

FIG. 7 is referred to again.

The loss computation unit 113b computes a loss between iris information and ground truth information by use of a parameter value derived by the parameter computation unit 113a.

### (Function of the Updating Unit 114)

The updating unit 114 updates a parameter value of an extraction model by use of a loss computed by the computation unit 113.

Specifically, for example, as illustrated in FIG. 7, the updating unit 114 functionally includes a gradient computation unit 114a and a parameter updating unit 114b.

The gradient computation unit 114a computes a gradient for a parameter of an extraction model by use of a loss computed by the loss computation unit 113b.

The parameter updating unit 114b updates a parameter value of an extraction model by use of the gradient computed by the gradient computation unit 114a.

### (Functional Configuration Example of the Capture Apparatus 102 According to the First Example Embodiment)

The capture apparatus 102 is a camera or the like that captures a target. The capture apparatus 102 performs capture, for example, in a case where a capture instruction is received, and thereby generates a target image.

The capture instruction is preferably output to the capture apparatus 102 from, for example, a sensor (not illustrated) for sensing that a target is located in a previously determined capture area, a detection apparatus (not illustrated) that detects a face from an image acquired by capturing a target with another capture apparatus (not illustrated), or the like.

Note that, a target image may include an iris of one eye of a target, and may be a binocular image including both eyes of a target, a monocular image including one of left and right eyes of a target, a face image including a face of a target, or a whole-body image including a whole body of a target.

### (Functional Configuration Example of the Comparison Apparatus 103 According to the First Example Embodiment)

As described above with reference to FIG. 3, the comparison apparatus 103 includes the extraction unit for comparison 131 and the comparison unit 132.

The extraction unit for comparison 131 is configured with, included therein, for example, an extraction model trained by use of the learning apparatus 101. The extraction unit for comparison 131 extracts with, as an input, a target image including an iris of a target, iris information of the target from the target image, by use of the trained extraction model. The extraction unit for comparison 131 preferably outputs the extracted iris information to the comparison unit 132.

The comparison unit 132 compares the iris information extracted by the extraction unit for comparison 131 with previously registered registration data. A result of the comparison can be used for, for example, recognition of whether a target has been previously registered. Note that, a purpose of the result of the comparison is not limited to thereto.

So far, the functional configuration example of the information processing system 100 according to the first example embodiment has been mainly described. From now on, a physical configuration example of the information processing system 100 according to the present example embodiment is described.

### (Physical Configuration of the Information Processing System 100)

The information processing system 100 is physically made up of the learning apparatus 101, the capture apparatus 102, and the comparison apparatus 103 that are connected via the network NT. Each of the learning apparatus 101, the capture apparatus 102, and the comparison apparatus 103 is made up of, for example, a single physically different apparatus.

Note that, some or all of the learning apparatus 101, the capture apparatus 102, and the comparison apparatus 103 may be physically made up of a single apparatus. Moreover, the learning apparatus 101, the capture apparatus 102, and the comparison apparatus 103 may be made up of, for example, for each of one or a plurality of functions included therein, a plurality of different apparatuses connected via an appropriate communication line such as a network NT.

Note that, the first computer group may be made up of one or a plurality of apparatuses including the function of the learning apparatus 101, and, in the present example embodiment, is made up of the learning apparatus 101. The second computer group may be made up of one or a plurality of apparatuses including the function of the comparison apparatus 103, and, in the present example embodiment, is made up of the comparison apparatus 103.

The learning apparatus 101 and the comparison apparatus 103 are preferably each similarly configured physically. Herein, a physical configuration example is described with reference to a figure with the learning apparatus 101 as an example.

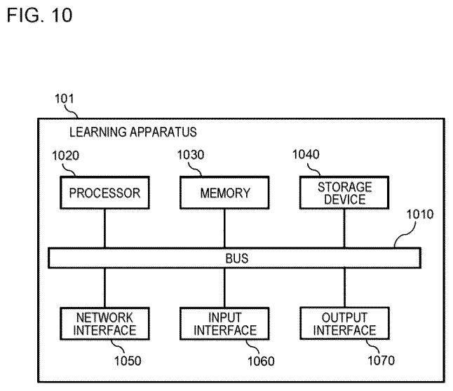

FIG. 10 is a diagram illustrating a physical configuration example of the learning apparatus 101 according to the first example embodiment. The learning apparatus 101 physically includes, for example, a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, the camera 1070, and a microphone 1080 transmit/receive data to/from each other. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving a function of an apparatus (in the example of FIG. 10, the learning apparatus 101) that includes the storage device 1040. The processor 1020 reads each of the program modules onto the memory 1030, executes the read program module, and thereby achieves a function associated with the program module.

The network interface 1050 is an interface for connecting an apparatus (in the example of FIG. 10, the learning apparatus 101) that includes the network interface 1050 to the network NT.

The input interface 1060 is an interface for a user to input information. The input interface 1060 is made up of, for example, a touch panel, a keyboard, a mouse, and the like.

The output interface 1070 is an interface for providing information to a user. The output interface 1070 is made up of, for example, a liquid crystal panel, an organic electro-luminescence (EL) panel, and the like.

Note that, the capture apparatus 102 preferably includes a camera as described above. The camera preferably includes the network interface 1050 for connecting to the network NT.

So far, the configuration example of the information processing system 100 according to the first example embodiment has been described. From now on, an operation of the information processing system 100 according to the present example embodiment is described.

### (Operation of the Information Processing System 100 According to the First Example Embodiment)

The information processing system 100 according to the first example embodiment executes information processing including learning processing executed by the learning apparatus 101 and comparison processing executed by the comparison apparatus 103. Each of pieces of the processing is described with reference to the drawings.

### (Example of Learning Processing According to the First Example Embodiment)

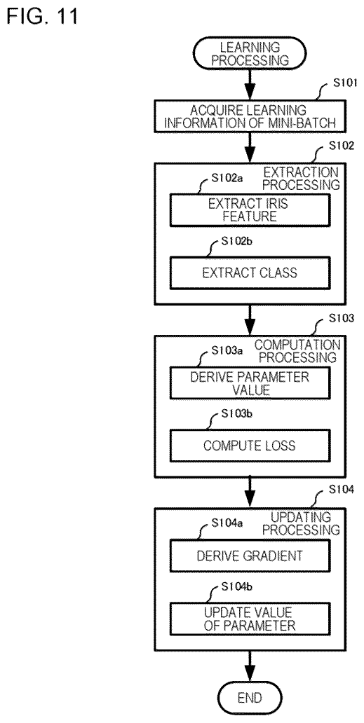

FIG. 11 is a flowchart illustrating an example of learning processing according to the first example embodiment. The learning processing is processing for performing training of an extraction model. The learning apparatus 101 starts the learning processing, for example, once the learning information acquisition unit 111 acquires learning information.

The learning information acquisition unit 111 acquires learning information of a mini-batch (step S101).

Specifically, for example, the learning information acquisition unit 111 randomly acquires learning information of a mini-batch from the whole learning information acquired as a start instruction of the learning processing. The learning information of the mini-batch is part of the learning information, and includes, for example, the number of images for training (e.g., 128 images) according to a previously determined batch size, and resolution of an iris region and ground truth information according to each image for training. The mini-batch learning information preferably includes an image for training with different resolution of an iris region.

The ground truth information according to the present example embodiment includes, for example, a class of an iris included in an image for training, as described above.

Note that, a batch size is not limited to 128, and may be previously determined as appropriate. Moreover, the learning information acquisition unit 111 may perform extension processing of an image for training.

The extraction unit 112 extracts iris information by use of an extraction model with an image for training acquired in step S101 as an input (step S102).

Specifically, for example, the feature extraction unit 112a extracts an iris feature by use of a feature extraction model with an image for training as an input (step S102a).

The classification unit 112b extracts a class being associated with an iris included in the image for training, by use of a classification model with the iris feature extracted in step S102a as an input (step S102b).

The computation unit 113 computes a loss between iris information extracted in step S102 and ground truth information acquired in step S101, by use of resolution of the iris region acquired in step S101 (step S103).

Specifically, for example, the parameter computation unit 113a derives a parameter value relating to a parameter for deriving a loss (step S103a).

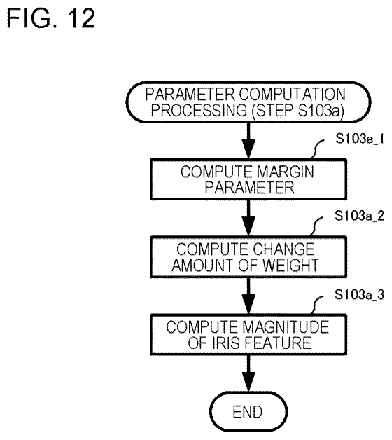

FIG. 12 is a flowchart illustrating an example of parameter computation processing (step S103a) according to the first example embodiment.

The margin computation unit 113a_1 computes a value of a margin parameter by use of resolution of the iris region acquired in step S101 (step S103a_1).

For example, as resolution of an iris region is lower, the margin computation unit 113a_1 computes a larger value for a margin parameter. In other words, the margin computation unit 113a_1 increases a value of a margin parameter for an image for training in which resolution of an iris region is low, and decreases a value of a margin parameter for an image for training in which resolution of an iris region is high.

The weight decay computation unit 113a_2 computes a value of a weight decay parameter by use of resolution of the iris region acquired in step S101 (step S103a_2).

For example, as resolution of an iris region is lower, the weight decay computation unit 113a_2 derives a smaller value for a weight decay parameter. In other words, the weight decay computation unit 113a_2 decreases a value of a weight decay parameter for an image for training in which resolution of an iris region is low, and decreases a value of a weight decay parameter for an image for training in which resolution of an iris region is high.

For example, the weight decay computation unit 113a_2 computes a value wd(r) of a weight decay parameter by use of wd(r)=wd0*(min(r,100)/100). wd0 is a value of a weight decay parameter before change, and is, for example, a constant. r is resolution of an iris region (e.g., the number of pixels of an iris diameter). min(a,b) is a function representing a smaller one of a and b. In the equation, the value wd(r) of the weight decay parameter becomes smaller according to resolution of an iris region in a case where resolution of an iris region is smaller than 100, and the value wd(r) of the weight decay parameter becomes a constant in a case where resolution of an iris region is equal to or more than 100.

The norm computation unit 113a_3 computes magnitude of an iris feature (step S103a_3). The magnitude of the iris feature is, for example, an iris diameter (e.g., a diameter or a radius) of an iris included in an image for training.

FIG. 11 is referred to again.

The loss computation unit 113b computes a loss between iris information and ground truth information by use of the parameter value derived in step S103a (step S103b).

For example, in typical CosFace, losses represented by Equations (1) and (2) are used. Moreover, for example, in typical ArcFace, a loss represented by equation (3) is used.

$$\begin{matrix}[ Mathematical 1 ] & \\ E = - \frac{1}{N} y {\sum }_{i = 1}^{N} log \frac{{e}^{s ( cos ( {θ}_{{y}_{i} , i} ) - m )}}{{e}^{s ( cos ( {θ}_{{y}_{i} , i} ) - m )} + {\sum }_{j \neq {y}_{i}} {e}^{s cos ( {θ}_{j , i} )}} & Equation 1\end{matrix}$$

$$\begin{matrix}[ Mathematical 2 ] & \\ cos {θ}_{j , i} = \frac{{W}_{j}^{T} F}{{‖ {W}_{j} ‖}_{2} {‖ {F}_{i} ‖}_{2}} & Equation 2\end{matrix}$$

$$\begin{matrix}[ Mathematical 3 ] & \\ E = - \frac{1}{N} y {\sum }_{i = 1}^{N} log \frac{{e}^{s ( cos ( {θ}_{{y}_{i} , i} + m )}}{{e}^{s ( cos ( {θ}_{{y}_{i} , i} + m )} + {\sum }_{j \neq {y}_{i}} {e}^{s cos ( {θ}_{j , i} )}} & Equation 3\end{matrix}$$

Herein, N is a batch size. θ_{yi,i} is an angle between a feature (Fᵢ) and a yᵢ-th column of a weight. S is a scaling parameter. m is a margin. W is a weight vector. The weight vector W is made up of components of dimensions of the number of classes CN×feature vector F F is a feature vector (vector quantity representing an iris feature). y is a one-hot vector representing a class (ground truth class) included in ground truth information. By minimizing the losses, a distance between a weight of a positive example and a class (vector quantity) can be reduced.

In step S103b, such a loss is corrected by use of a parameter value derived in step S103a.

Specifically, for example, the loss computation unit 113b uses the value of the margin parameter computed in step S103a_1, in order to compute a loss.

For example, the loss computation unit 113b uses the value of the weight decay parameter computed in step S103a_2, in order to compute a loss.

For example, in a case where the resolution of the iris region acquired in step S101 is equal to or less than a predetermined value, the loss computation unit 113b computes a loss in such a way that magnitude of the iris feature computed in step S103a_3 becomes closer to a predetermined criterion value. Herein, the predetermined criterion value is magnitude of an iris feature extracted from an image for training in which resolution of an iris region is a predetermined value.

Herein, in a case where a criterion value is DO and magnitude of the iris feature computed in step S103a_3 is D, for example, the loss computation unit 113b further uses |max(D0−D), 0| for a loss E. max(A, B) is a function representing a larger value of A and B.

The updating unit 114 updates the value of the parameter of the extraction model by use of the loss computed in step S103 (step S104).

Specifically, for example, the gradient computation unit 114a computes a gradient for the parameter of the extraction model by use of the loss computed in step S103b (step S104a).

In step S104a, for example, the gradient computation unit 114a computes, by use of the loss computed in step S103b, a gradient for the parameter of the extraction model by error back-propagation.

The parameter updating unit 114b updates the value of the parameter of the extraction model by use of the gradient computed in step S104a (step S104b), and ends the learning processing.

In step S104b, for example, the parameter updating unit 114b updates the parameter of the extraction model by use of the gradient computed in step S104a and a previously set training rate.

Such learning processing is preferably executed repeatedly, for example, according to a previously determined number of times. A class extracted in step S102b becomes a random value (e.g., a vector quantity) in an initial stage of training, but becomes a value close to a one-hot vector representing a ground truth class as training progresses. Thereby, training of an extraction model can be performed.

Note that, in a case where a change in the loss computed in step S103 becomes equal to or less than a previously determined threshold, the loss computation unit 113b may end the learning processing even though the number of repetition times of learning processing is less than a previously determined number.

### (Example of Comparison Processing According to the First Example Embodiment)

The comparison processing according to the first example embodiment includes, for example, the processing described above with reference to FIG. 5. The comparison processing is processing for comparing a target by use of a target image and a trained extraction model (or a feature extraction model). The comparison apparatus 103 starts the comparison processing, for example, once the extraction unit for comparison 131 acquires a target image including an iris of a target.

The extraction unit for comparison 131 extracts, by use of an extraction model with a target image including an iris of a target as an input, iris information of the target from the target (step S201).

The extraction model used herein is an extraction model trained by repeatedly executing learning processing. Note that, in step S201, only a feature extraction model may be applied.

Moreover, the iris information extracted in step S201 may include, for example, an iris feature.

The comparison unit 132 compares the iris information extracted in step S201 with previously registered data (step S202), and ends the comparison processing.

For example, the comparison unit 132 preferably outputs, as a result of a comparison, for example, a similarity degree between an extracted iris feature and an iris feature included in registered data, or the like. Moreover, for example, the comparison unit 132 may output, as a result of a comparison, information, included in registered data, for identifying an individual, such as an individual identifier (ID) assigned to each individual, and an individual name, regarding the registered data in which a similarity degree of an iris feature included in the registered data is equal to or more than a threshold value or is the largest.

### Advantage and Effect

As described above, according to the present example embodiment, the learning apparatus 101 includes the extraction unit 112, the computation unit 113, and the updating unit 114. The extraction unit 112 extracts iris information relating to an iris by using an extraction model that trains with an image for training including an iris as an input. The computation unit 113 computes a loss between iris information and ground truth information by use of resolution of an iris region included in the image for training. The updating unit 114 updates a value of a parameter of the extraction model by use of the computed loss.

Thereby, the value of the parameter of the extraction model can be updated by use of a loss according to resolution of an iris region included in an image for training. Therefore, even in a case where resolution of an iris region is low in a target image including an iris of a target, it becomes possible to acquire information with good accuracy from an image of the iris region.

According to the present example embodiment, the computation unit 113 includes the parameter computation unit 113a and the loss computation unit 113b. The parameter computation unit 113a derives a parameter value relating to a parameter for deriving a loss. The loss computation unit 113b computes a loss between iris information and ground truth information by use of the parameter value.

Thereby, a value of a parameter of an extraction model can be updated by use of a loss according to resolution of an iris region included in an image for training. Therefore, even in a case where resolution of an iris region included in a target image is low, it becomes possible to acquire information with good accuracy from an image of the iris region.

According to the present example embodiment, a parameter value includes at least one of (1) a value of a margin parameter being a hyperparameter included in a loss function for deriving a loss, (2) a value of a weight decay parameter, and (3) magnitude of an iris feature.

A parameter value includes (1) a value of a margin parameter, and thereby, an extraction model excelling in identification performance for a target image including irises of different persons can be constructed even in a case where resolution of an iris region included in the target image is low.

A parameter value includes (2) a value of a weight decay parameter, and thereby, similarly, an extraction model excelling in identification performance for a target image including irises of different persons can be constructed even in a case where resolution of an iris region included in the target image is low.

A parameter value includes (3) magnitude of an iris feature, and thereby, a loss according to resolution of an iris region can be derived even in a case where resolution of the iris region included in a target image is low.

Therefore, even in a case where resolution of an iris region is low in a target image including an iris of a target, it becomes possible to acquire information with good accuracy from an image of the iris region.

According to the present example embodiment, a parameter value includes (1) a value of a margin parameter being a hyperparameter included in a loss function. The parameter computation unit 113a includes the margin computation unit 113a_1 that derives a larger value for a margin parameter as resolution of an iris region is lower.

By placing a constraint on a margin parameter in this way, an extraction model excelling in identification performance for a target image including irises of different persons can be constructed even in a case where resolution of an iris region included in the target image is low. Therefore, even in a case where resolution of an iris region is low in a target image including an iris of a target, it becomes possible to acquire information with good accuracy from an image of the iris region.

According to the present example embodiment, a parameter value includes (2) a value of a weight decay parameter. The parameter computation unit 113a includes a weight decay computation unit 113a_2 that derives a small value for a weight decay parameter as resolution of an iris region is lower.

By placing a constraint on a weight decay parameter in this way, an extraction model excelling in identification performance for a target image including irises of different persons can be constructed even in a case where resolution of an iris region included in the target image is low. Therefore, even in a case where resolution of an iris region is low in a target image including an iris of a target, it becomes possible to acquire information with good accuracy from an image of the iris region.

According to the present example embodiment, a parameter value includes (3) magnitude of an iris feature. The parameter computation unit 113a includes the norm computation unit 113a_3 that derives magnitude of an iris feature. The loss computation unit 113b computes a loss between iris information and ground truth information in such a way that magnitude of an iris feature becomes closer to a previously determined criterion value in a case where resolution of an iris region is equal to or less than a predetermined value. The previously determined criterion value is magnitude of an iris feature extracted from an image for training in which resolution of an iris region is a predetermined value.

Thereby, in a case where resolution of an iris region included in an image for training is low, a constraint can be placed in such a way that the resolution of the iris region is kept constant. Thus, an extraction model excelling in identification performance for a target image including irises of different persons can be constructed even in a case where resolution of an iris region included in the target image is low. Therefore, even in a case where resolution of an iris region is low in a target image including an iris of a target, it becomes possible to acquire information with good accuracy from an image of the iris region.

According to the present example embodiment, iris information includes at least one of an iris feature extracted from an image for training, an image of an iris region in an image for training, a position of a feature location, and a class being associated with an iris included in an image for training.

Thereby, various pieces of iris information can be acquired by use of an extraction model. Therefore, even in a case where resolution of an iris region included in a target image is low, it becomes possible to acquire various pieces of information with good accuracy from an image of the iris region.

### First Modified Example

As described above, a parameter value may include at least one of (1) a value of a margin parameter, (2) a value of a weight decay parameter, and (3) magnitude of an iris feature. In other words, a parameter value may be any one or two of (1) to (3).

In this case, according to which of (1) to (3) a parameter value includes, a parameter computation unit 113a preferably includes one or more of a margin computation unit 113a_1, a weight decay computation unit 113a_2, and a norm computation unit 113a_3 for deriving each of (1) to (3). Moreover, parameter computation processing (step S103a) preferably includes one or more of steps 103a_1 to 103a_3 for computing each of (1) to (3) according to which of (1) to (3) a parameter value includes. In step S103b, a loss is preferably corrected by use of a parameter value computed in any of steps 103a_1 to 103a_3.

This modified example also provides an average similar to that according to the first example embodiment.

### Second Modified Example

In the present modified example, an example of a loss function for computing a loss by use of resolution of an iris region included in an image for training in a case where iris information includes an image of the iris region is described.

A loss E2 according to the present modified example is, for example, a value acquired by dividing a loss E (refer to Equation 4) using L1 norm between an extraction map indicating an image of an iris region and a ground truth map indicating an image of an iris region included in ground truth information, by resolution of an iris region included in an image for training (e.g., the number of pixels of an iris diameter).

$$\begin{matrix}[ Mathematical 3 ] & \\ E = {\sum }_{j}^{M} \frac{1}{{R}_{j}} \frac{1}{N} {\sum }_{i}^{N} \vert {y}_{i} \to {f ( x )}_{i} \vert & Equation 4\end{matrix}$$

Herein, j is information (image ID) for identifying an image for training included in a batch. M is the number of samples. Rⱼ is resolution of an iris region included in the j-th image for training. i is a value indicating each pixel. N is a total number of pixels in an image for training. yᵢ is the pixel value of a ground truth map. x is a vector quantity made up of a pixel value of an image for training. f(x)ᵢ is a pixel value of an extraction map. Note that, a loss E2 is not limited thereto, and may be, for example, other than L1 norm.

This modified example also provides an average similar to that according to the first example embodiment.

### Third Modified Example

In the present modified example, an example of a loss function for computing a loss by use of resolution of an iris region included in an image for training in a case where the iris information includes a position of a feature location is described.

A loss E3 according to the present modified example is, for example, a value acquired by dividing a loss E using L1 norm between an extraction position being a position of an extracted feature location, and the ground truth position indicating a position of a feature location included in a ground truth information, by resolution of an iris region included in an image for training (e.g., the number of pixels of an iris diameter). The loss E herein may be the loss E computed by use of Equation (4), similar to the second modified example.

However, in the present modified example, j is information (image ID) for identifying an image for training included in a batch. M is the number of samples. Rⱼ is resolution of an iris region included in a jth image for training. i is a value indicating each pixel. N is a total number of pixels in an image for learning. yᵢ is a ground truth position. x is a vector quantity made up of a pixel value of an image for training. f(x)ᵢ is an extraction position. For example, in a case where three feature locations are three, elements making up positions thereof are three x coordinates and three y coordinates totaling six elements. Note that, the loss E3 is not limited thereto, and may be, for example, other than L1 norm.

This modified example also provides an average similar to that according to the first example embodiment.

### Second Example Embodiment

In a second example embodiment, an example in which a parameter value in a case where the parameter value includes (3) magnitude of an iris feature is changed is described. In the present example embodiment, in order to simplify description, description overlapping with the first example embodiment is omitted as appropriate.

A parameter value according to the present example embodiment includes (3) magnitude of an iris feature. The parameter value according to the present example embodiment is different from that according to the first example embodiment in that magnitude of each of a plurality of iris features is included. A plurality of iris features include, for example, a low-resolution feature and a high-resolution feature respectively extracted from a low-resolution image for training and a high-resolution image for training that share ground truth information in common but are different in resolution of an iris region.

The low-resolution image for training and the high-resolution image for training are an image for training with low resolution in an iris region and an image for training with high resolution in an iris region, respectively. The low-resolution feature and the high-resolution feature are an iris feature extracted from a low-resolution image for training and an iris feature extracted from a high-resolution image for training, respectively.

A norm computation unit 113a_3 according to the present example embodiment preferably derives magnitude of each of the low-resolution feature and the high-resolution feature.

The loss computation unit 113b according to the present example embodiment preferably computes a loss between iris information and ground truth information in such a way that magnitude of the low-resolution feature becomes closer to magnitude of the high-resolution feature. Herein, in a case where magnitude of a high-resolution feature is DH and magnitude of a low-resolution feature is DL, for example, a loss computation unit 113b preferably further uses |DH−DL| for a loss E.

Note that, in a case where the loss is used, there is a possibility that magnitude DH of the high-resolution feature becomes closer to magnitude DL of the low-resolution feature. In order to reduce the possibility, a minimum value DO may be previously determined for the magnitude DH of a high-resolution feature. In this case, for example, |max(DH, D0)−DL| may be further used for the loss E.

### Advantage and Effect

As described above, according to the present example embodiment, a parameter value includes magnitude of each of a plurality of iris features. The plurality of iris features include a low-resolution feature and a high-resolution feature respectively extracted from a low-resolution image for training and a high-resolution image for training that share ground truth information in common but are different in resolution of an iris region.

A parameter computation unit 113a includes a norm computation unit 113a_3 that derives magnitude of each of a low-resolution feature and a high-resolution feature. The loss computation unit 113b computes a loss between iris information and ground truth information in such a way that magnitude of the low-resolution feature becomes closer to magnitude of the high-resolution feature.

By placing such a constraint on a loss, training of an extraction model can be performed in such a way as to bring iris information extracted from an image of an iris region with low resolution closer to iris information extracted from an image of an iris region with high resolution. Thus, an extraction model excelling in identification performance for a target image including irises of different persons can be constructed even in a case where resolution of an iris region included in a target image is low. Therefore, even in a case where resolution of an iris region is low in a target image including an iris of a target, it becomes possible to acquire information with good accuracy from an image of the iris region.

### Third Example Embodiment

In a third example embodiment, an example of changing a training rate for updating a parameter of an extraction model is described. In the present example embodiment, in order to simplify description, description overlapping with the first example embodiment is omitted as appropriate.

A parameter updating unit 114b according to the present example embodiment applies different training rates to a feature extraction model and a classification model. For example, a training rate of the feature extraction model is preferably a real number multiple (however, the real number is larger than 1) of the training rate of the classification model, or an integer multiple of 2, 3, 4, 5, or the like.

In parameter updating processing (step S104b) according to the present example embodiment, the parameter updating unit 114b preferably updates a parameter of an extraction model by use of a gradient computed in step S104a and different training rates for the feature extraction model and the classification model.

### Advantage and Effect

As described above, according to the present example embodiment, an extraction model includes a feature extraction model that extracts an iris feature with an image for training as an input, and a classification model that extracts, with the iris feature as an input, a class being associated with an iris included in an image for training. An updating unit 114 applies different training rates to the feature extraction model and the classification model.

Thereby, the feature extraction model and the classification model can be trained at different amplitudes. For example, the feature extraction model can be trained at a larger amplitude than the classification model. Since magnitude of an iris feature becomes larger, an effect of training using a loss computed by a loss computation unit 113b can be much larger, it becomes difficult for magnitude of a high-resolution feature to become small, and it becomes easy for magnitude of a low-resolution feature to be large.

Thus, an extraction model excelling in identification performance for a target image including irises of different persons can be constructed even in a case where resolution of an iris region included in a target image is low. Therefore, even in a case where resolution of an iris region is low in a target image including an iris of a target, it becomes possible to acquire information with good accuracy from an image of the iris region.

### Fourth Example Embodiment

In a fourth example embodiment, an example in which a gradient of a feature extraction model is multiplied by a constant is described. In the present example embodiment, in order to simplify description, description overlapping with the first example embodiment is omitted as appropriate.

A gradient computation unit 114a according to the present example embodiment multiplies, by a constant, a gradient derived regarding a feature extraction model. The constant may be a real number larger than 1, or may be an integer such as 2, 3, 4, or 5.

In gradient computation processing (step S104a) according to the present example embodiment, the gradient computation unit 114a computes a gradient for a parameter for each of a feature extraction model and a classification model. Then, the gradient computation unit 114a multiplies, by a constant, the gradient derived regarding the feature extraction model.

In parameter updating processing (step S104b) according to the present example embodiment, a parameter updating unit 114b updates a parameter regarding the feature extraction model by use of the gradient multiplied by a constant. Regarding an extraction model, similar to the first example embodiment, the parameter updating unit 114b preferably updates a parameter by use of the gradient derived in step S104a. Moreover, in the present example embodiment, a training rate of each of the feature extraction model and the classification model may be the same similar to the first example embodiment, or may be different similar to the third example embodiment.

### Advantage and Effect

As described above, according to the present example embodiment, the extraction model includes a feature extraction model that extracts iris features with an image for training as an input, and a classification model that extracts, with the iris feature as an input, a class being associated with an iris included in the image for training. The updating unit 114 includes the gradient computation unit 114a and the parameter updating unit 114b. The gradient computation unit 114a computes a gradient for a parameter of an extraction model by use of the computed loss. The parameter updating unit 114b computes and updates the parameter of the extraction model by use of the computed gradient. The parameter updating unit 114b uses, in computation of a parameter of the extraction model, a value acquired by multiplying the computed gradient by a previously determined constant.

Thereby, similar to the third example embodiment, the feature extraction model and the classification model can be trained at different amplitudes. For example, the feature extraction model can be trained at a larger amplitude than the classification model. Since magnitude of an iris feature becomes larger, an effect resulting from correction of a loss can be much larger, it becomes more difficult for magnitude of a high-resolution feature to become small, and it becomes easier for magnitude of a low-resolution feature to be large.

Thus, an extraction model excelling in identification performance for a target image including irises of different persons can be constructed even in a case where resolution of an iris region included in a target image is low. Therefore, even in a case where resolution of an iris region is low in a target image including an iris of a target, it becomes possible to acquire information with good accuracy from an image of the iris region.

The example embodiments and the modified examples according to the present invention have been described above with reference to the drawings, but are exemplifications of the present invention, and various configurations other than those described above can be adopted.

Moreover, although a plurality of processes (pieces of processing) are described in order in a plurality of flowcharts used in the above-described description, an execution order of processes executed in each example embodiment is not limited to the described order. In each example embodiment, an order of illustrated processes can be changed to an extent that causes no problem in terms of content. Moreover, each of the example embodiments and modified examples described above can be combined to an extent that content does not contradict.

Some or all of the above-described example embodiments can also be described as, but are not limited to, the following supplementary notes.
1. An information processing system including:
   an extraction unit that uses an extraction model of training with, as an input, an image for training including an iris, and thereby extracts iris information relating to the iris;
   a computation unit that computes, by use of resolution of an iris region included in the image for training, a loss between the iris information and ground truth information; and
   an updating unit that updates, by use of the computed loss, a value of a parameter of the extraction model.
2. The information processing system according to supplementary note 1, wherein
   the computation unit includes
   a parameter computation unit that derives a parameter value relating to a parameter for deriving the loss, and
   a loss computation unit that computes a loss between the iris information and ground truth information by use of the parameter value.
3. The information processing system according to supplementary note 2, wherein
   the parameter value includes at least one of (1) a value of a margin parameter being a hyperparameter included in a loss function for deriving the loss, (2) a value of a weight decay parameter included in a loss function for deriving the loss, and (3) magnitude of an iris feature.
4. The information processing system according to supplementary note 3, wherein
   the parameter value includes a value of a margin parameter being a hyperparameter included in the loss function, and
   the parameter computation unit includes a margin computation unit that derives a larger value for the margin parameter as resolution of the iris region is lower.
5. The information processing system according to supplementary note 3 or 4, wherein
   the parameter value includes a value of the weight decay parameter, and
   the parameter computation unit includes a weight decay computation unit that derives a smaller value for the weight decay parameter as resolution of the iris region is lower.
6. The information processing system according to any one of supplementary notes 3 to 5, wherein
   the parameter value includes magnitude of the iris feature,
   the parameter computation unit includes a norm computation unit that derives magnitude of the iris feature,
   the loss computation unit computes a loss between the iris information and ground truth information in such a way that magnitude of the iris feature becomes closer to a previously determined criterion value in a case where resolution of the iris region is equal to or less than a predetermined value, and
   the previously determined criterion value is magnitude of an iris feature extracted from the image for training in which resolution of the iris region is a predetermined value.
7. The information processing system according to any one of supplementary notes 3 to 5, wherein
   the parameter value includes magnitude of each of a plurality of the iris features,
   the plurality of iris features include a low-resolution feature and a high-resolution feature respectively extracted from a low-resolution image for training and a high-resolution image for training that share the ground truth information in common but are different in resolution of the iris region,
   the parameter computation unit includes a norm computation unit that derives magnitude of each of the low-resolution feature and the high-resolution feature, and
   the loss computation unit computes a loss between the iris information and ground truth information in such a way that magnitude of the low-resolution feature becomes closer to magnitude of the high-resolution feature.
8. The information processing system according to any one of supplementary notes 1 to 7, wherein
   the iris information includes at least one of an iris feature extracted from the image for training, an image of an iris region in the image for training, a position of a feature location, and a class being associated with an iris included in the image for training.
9. The information processing system according to any one of supplementary notes 1 to 8, wherein
   the extraction model includes
   a feature extraction model that extracts the iris feature with the image for training as an input, and
   a classification model that extracts, with the iris feature as an input, a class being associated with an iris included in the image for training, and
   the updating unit applies different training rates to the feature extraction model and the classification model.
10. The information processing system according to any one of supplementary notes 1 to 8, wherein
   the extraction model includes
   a feature extraction model that extracts the iris information with the image for training as an input, and
   a classification model that extracts, with the iris information as an input, a class being associated with an iris included in the image for training,
   the updating unit includes
   a gradient computation unit that computes a gradient for a parameter of the extraction model by use of the computed loss, and
   a parameter updating unit that computes and updates a parameter of the extraction model by use of the computed gradient, and
   the parameter updating unit uses, in computation of a parameter of the extraction model, a value acquired by multiplying the computed gradient by a previously determined constant.
11. A learning apparatus including:
   an extraction unit that uses an extraction model with, as an input, an image for training including an iris, and thereby extracts iris information relating to the iris;
   a computation unit that computes, by use of resolution of an iris region included in the image for training, a loss between the iris information and ground truth information; and
   an updating unit that updates, by use of the computed loss, a value of a parameter of the extraction model.
12. A comparison apparatus including:
   an extraction unit for comparison that extracts with, as an input, a target image including an iris of a target, iris information relating to the iris of the target, by use of the extraction model trained by use of the learning apparatus according to supplementary note 11; and
   a comparison unit that compares the iris information of the target with previously registered registration data.
13. An information processing method including,
   by a first computer group made up of one or more computers:
   using an extraction model of training with, as an input, an image for training including an iris, and thereby extracting iris information relating to the iris;
   computing, by use of resolution of an iris region included in the image for training, a loss between the iris information and ground truth information; and
   updating, by use of the computed loss, a value of a parameter of the extraction model.
14. An information processing method including,
   by a second computer group made up of one or more computers:
   extracting with, as an input, a target image including an iris of a target, iris information relating to the iris of the target, by use of the extraction model that the first computer group has trained by executing the information processing method according to supplementary note 13; and
   comparing the iris information of the target with previously registered registration data.
15. A medium recording a program for causing
   a first computer group made up of one or more computers to execute:
   using an extraction model of training with, as an input, an image for training including an iris, and thereby extracting iris information relating to the iris;
   computing, by use of resolution of an iris region included in the image for training, a loss between the iris information and ground truth information; and
   updating, by use of the computed loss, a value of a parameter of the extraction model.
16. A medium recording a program for causing
   a second computer group made up of one or more computers to execute:
   extracting with, as an input, a target image including an iris of a target, iris information relating to the iris of the target, by use of the extraction model trained by causing the first computer group to execute a program recorded on the medium according to supplementary note 15; and
   comparing the iris information of the target with previously registered registration data.

### REFERENCE SIGNS LIST

100 Information processing system
101 Learning apparatus
102 Capture apparatus
103 Comparison apparatus
111 Learning information acquisition unit
112 Extraction unit
112a Feature extraction unit
112b Classification unit
113 Computation unit
113a Parameter computation unit
113a_1 Margin computation unit
113a_2 Weight decay computation unit
113a_3 Norm computation unit
113b Loss computation unit
114 Updating unit
114a Gradient computation unit
114b Parameter updating unit
131 Extraction unit for comparison
132 Comparison unit

1. An information processing system comprising:
at least one memory storing instructions; and
at least one processor configured to execute the instructions including:
using an extraction model of training with, as an input, an image for training including an iris, to extract iris information relating to the iris;
computing, by use of resolution of an iris region included in the image for training, a loss between the iris information and ground truth information; and
updating, by use of the computed loss, a value of a parameter of the extraction model.

2. The information processing system according to claim 1, wherein
computing the loss includes
deriving a parameter value relating to a parameter for deriving the loss, and
computing the loss between the iris information and ground truth information by use of the parameter value.

3. The information processing system according to claim 2, wherein
the parameter value includes at least one of (1) a value of a margin parameter being a hyperparameter included in a loss function for deriving the loss, (2) a value of a weight decay parameter included in a loss function for deriving the loss, and (3) magnitude of an iris feature.

4. The information processing system according to claim 3, wherein
the parameter value includes a value of a margin parameter being a hyperparameter included in the loss function, and
deriving the parameter value relating to the parameter includes deriving a larger value for the margin parameter as resolution of the iris region is lower.

5. The information processing system according to claim 3, wherein
the parameter value includes a value of the weight decay parameter, and
deriving the parameter value relating to the parameter includes deriving a smaller value for the weight decay parameter as resolution of the iris region is lower.

6. The information processing system according to claim 3, wherein
the parameter value includes magnitude of the iris feature,
deriving the parameter value relating to the parameter includes deriving magnitude of the iris feature,
the loss between the iris information and ground truth information is computed in such a way that magnitude of the iris feature becomes closer to a previously determined criterion value in a case where resolution of the iris region is equal to or less than a predetermined value, and
the previously determined criterion value is magnitude of an iris feature extracted from the image for training in which resolution of the iris region is a predetermined value.

7. The information processing system according to claim 3, wherein
the parameter value includes magnitude of each of a plurality of the iris features,
the plurality of iris features include a low-resolution feature and a high-resolution feature respectively extracted from a low-resolution image for training and a high-resolution image for training that share the ground truth information in common but are different in resolution of the iris region,
deriving the parameter value relating to the parameter includes deriving magnitude of each of the low-resolution feature and the high-resolution feature, and
the loss between the iris information and ground truth information is computed in such a way that magnitude of the low-resolution feature becomes closer to magnitude of the high-resolution feature.

8. The information processing system according to claim 1, wherein
the iris information includes at least one of an iris feature extracted from the image for training, an image of an iris region in the image for training, a position of a feature location, and a class being associated with an iris included in the image for training.

9. The information processing system according to claim 1, wherein
the extraction model includes
a feature extraction model that extracts the iris feature with the image for training as an input, and
a classification model that extracts, with the iris feature as an input, a class being associated with an iris included in the image for training,
updating values of parameters of the feature extraction model and the classification model, and
different training rates are applied to updating the values of the parameters of the feature extraction model and the classification model.

10. The information processing system according to claim 1, wherein
the extraction model includes
a feature extraction model that extracts the iris information with the image for training as an input, and
a classification model that extracts, with the iris information as an input, a class being associated with an iris included in the image for training,
updating values of parameters of the feature extraction model and the classification model includes
computing a gradient for a parameter of the extraction model by use of the computed loss, and
computing and updating a parameter of the extraction model by use of the computed gradient, and
using, in computation of a parameter of the extraction model, a value acquired by multiplying the computed gradient by a previously determined constant.

11. (canceled)

12. (canceled)

13. An information processing method comprising,
by a first computer group made up of one or more computers:
using an extraction model of training with, as an input, an image for training including an iris, and thereby extracting iris information relating to the iris;
computing, by use of resolution of an iris region included in the image for training, a loss between the iris information and ground truth information; and
updating, by use of the computed loss, a value of a parameter of the extraction model.

14. (canceled)

15. A non-transitory computer readable medium recording a program for causing
a first computer group made up of one or more computers to execute:
using an extraction model of training with, as an input, an image for training including an iris, and thereby extracting iris information relating to the iris;
computing, by use of resolution of an iris region included in the image for training, a loss between the iris information and ground truth information; and
updating, by use of the computed loss, a value of a parameter of the extraction model.

16. (canceled)
